(19) United States
(12) Patent Application Publication
(10) Pub. No.: US 2005/0082196 A1
(43) Pub. Date: Apr. 21, 2005

(54) Waste paper basket

(75) Inventor: Daphne Lin, Taipei City (TW)

Correspondence Address: BACON & THOMAS, PLLC, 625 SLATERS LANE, FOURTH FLOOR, ALEXANDRIA, VA, 22314, US

(73) Assignee: Test Rite International Company, LTD., Taipei City (TW)

(21) Appl. No.: 10/978,458

(22) Filed: Nov. 2, 2004

(30) Foreign Application Priority Data
Jan. 29, 2003 (TW) 03201448.1

(51) Int. Cl. B65F 1/00; B65D 1/34

(52) U.S. Cl. 206/554; 220/908; 220/909; D34/1

(57) ABSTRACT

A waste paper basket comprises a body, a lid, a pedal unit, a basket base, a pivotal portion, a fixation portion and a handle. The pedal unit comprises a pedal and a linkage; the basket base comprises a base, a roller and a supporting base plate; the body is fastened on the basket base; the lid is sleeve jointed to the body; the linkage is connected to the pedal and the fixation portion; the handle is plugged into the pivotal portion, which is connected to the fixation portion and assembled on the external periphery of the junction of the lid and the body. A roller cap passes through a hole of the body and then is sleeve jointed to the roller. It is possible to place waste bags inside the roller of the waste paper basket in advance, so that when the waste bag on the supporting base plate is taken out for disposal, a new waste bag is drawn out from the roller along with the old waste bag.

### FIELD OF THE INVENTION

The present invention relates to a waste paper basket, and more particularly to an improved waste paper basket that is capable of automatically drawing out waste bags.

### BACKGROUND OF THE INVENTION

Commonly used waste paper baskets are generally available in two designs, namely, the open type and the closed type. The closed-type waste paper basket is constructed by assembling a top-supporting rack on the back of a basket body, and one lower end of the top-supporting rack is pivotally connected to one end of a pedal disposed on a bottom side of the basket body as an integrated unit; moreover, one upper end of the top-supporting rack is pivotally connected to a lid of the waste paper basket at a suitable location to be used as a pivot as a whole, such that when a user presses down the pedal installed on the lower end of the basket body by foot, top-supporting rack rises upward and actuates the lid to be lifted open upward, until the top-supporting rack moves upward to the uppermost limit, so as to position the lid on the top of the basket body. Moreover, because the top-supporting rack and the lid are in a pivotal state, and after the user's foot has released the pedal, it is not possible to make the lid move downward and then close it together with the basket body. As such, the user has to resort to an external force to pull down the lid to make it close on the top of the opening of the basket body.

The waste bags placed inside conventional waste paper baskets are made available by cutting a single bag from a roll of bags by a user in advance and then placing the single bag into the waste paper basket. After the waste bag inside the waste paper basket has been packed and disposed of, the user needs to cut another bag for placing inside the conventional waste paper basket. Hence the conventional way of bag replacement is inconvenient and has room for improvement.

### SUMMARY OF THE INVENTION

No prior art has disclosed the incorporation of a roller into a waste paper basket. The primary object of the present invention is to provide a waste paper basket with a roller disposed on the basket base, so that an opening for supporting a base plate is connected to the roller. Moreover, it is also possible to place the waste bag inside the roller in advance that when the waste bag placed on the supporting base plate is pulled out for disposal, a new waste bag will be drawn out from the roller along with the old waste bag.

In one of preferred embodiments of the present invention, a waste paper basket comprises a body, a lid, a pedal unit, a basket base, a pivotal portion, a fixation portion and a handle; the pedal unit comprises a pedal, a linkage and a rod; the basket base comprises a base, a roller and a supporting base plate; characterized in which the body is fastened on the basket base; the lid is sleeve jointed to the body; the pedal is plugged into one end of the linkage; another end of the linkage is apically joined to one end of the rod; another end of the rod is connected to the fixation portion; the handle is plugged into the pivotal portion, which is connected to the fixation portion, and then assembled on the external periphery of the junction of the lid and the body; a roller cap passes through a hole of the body and is then sleeve jointed to the roller.

One preferred embodiment of the present invention discloses a waste paper basket that comprises a body and a basket base; the body is fastened on the basket base; the basket base comprises a base, a roller and a supporting base plate; the roller has an opening and is disposed on the base; a roller cap passes through a hole of the body and is then sleeve jointed to the roller.

### BRIEF DESCIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a perspective view of the waste paper basket according to a first embodiment of the present invention.

FIG. 2 shows a cross-sectional view along line A-A of FIG. 1.

FIG. 3 shows a perspective view of a basket base of the waste paper basket of the present invention.

FIG. 4 shows a cross sectional view of the waste paper basket according to a second embodiment of the present invention.

### DETAILED DESCRIPTION OF THE PREFERRED EMBODIMENTS

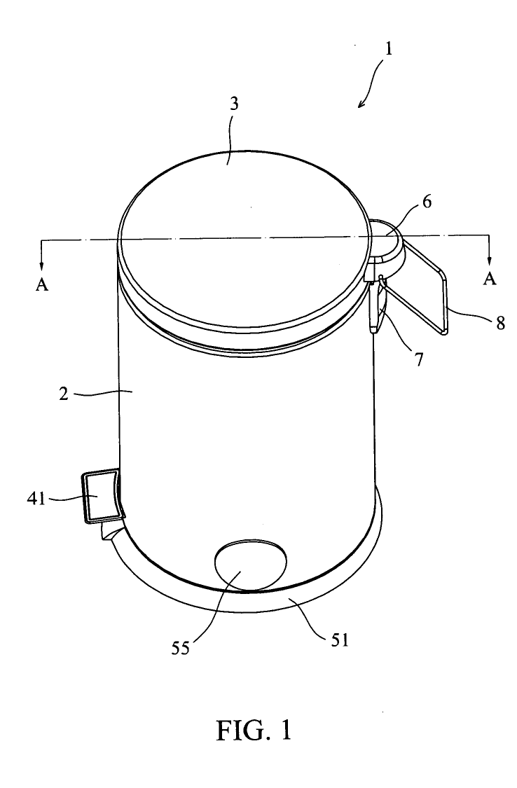

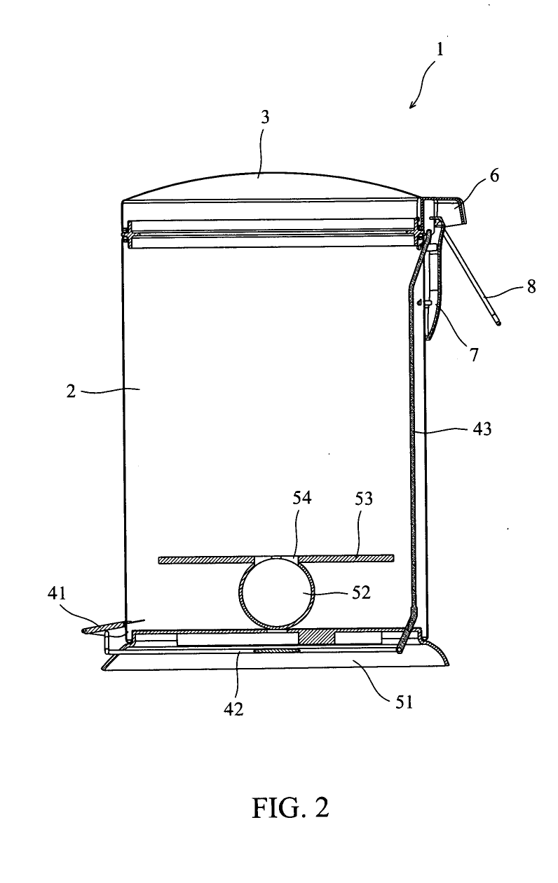

As shown in FIG. 1 and FIG. 2, wherein a longitudinal cross sectional view of a waste paper basket 1 of the present invention in FIG. 2 is made with reference to a basket base 5, a pedal unit 4, a pivotal portion 6 and a fixation portion 7 to show the cross sectional view of the waste paper basket 1. The waste paper basket 1 of the present invention comprises: a body 2, a lid 3, a pedal unit 4, a basket base 5, a pivotal portion 6, a fixation portion 7 and a handle 8; the pedal unit 4 comprises a pedal 41, a linkage 42 and a rod 43; the basket base 5 comprises a base 51, a roller 52 and a supporting base plate 53; the body 2 is fastened on the base 51; the lid 3 is sleeve jointed to the body 2; the pedal 41 is plugged into one end of the linkage 42; another end of the linkage 42 is apically joined to one end of the rod 43; another end of the rod 43 is connected to the fixation portion 7; the handle 8 is plugged into the pivotal portion 6, which is connected to the fixation portion 7, and assembled on the back-side periphery of the junction of the lid 3 and body 2; a roller cap 55 passes through a hole (which is not shown in the drawing) of the body 2 and is then sleeve jointed to the roller 52.

When the user presses down or releases the pedal 41, it is possible to make the linkage 42 actuate the rod 43 to produce reciprocating inertia, so that the lid 3 connected to the rod 43 is actuated by its linkage so as to lift open and close. The handle 8 is provided to enhance portability of the waste paper basket 1. (This part is a prior art and will not be discussed herein.)

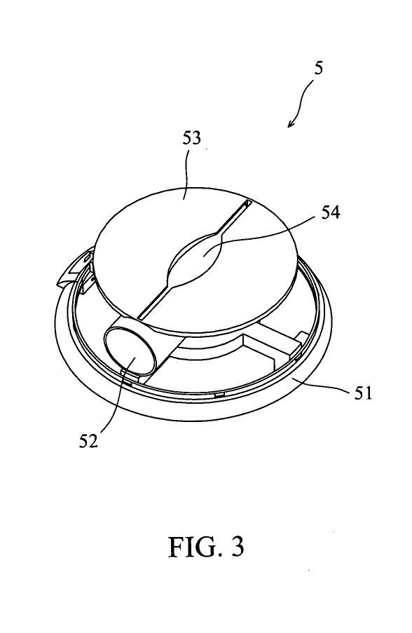

As shown in FIG. 3, the base 51 is fastened on the basket base 5 and is used to dispose the body 2 to provide a support for the entire product; the roller 52 is fastened on the base 51, and has an opening 54, which is used to place waste bags, and the supporting base plate 53 is fastened on the roller 52 and is used to support waste bags.

The user can place a roll of waste bags inside the roller 52 in advance, and when the waste bag on the supporting base plate 53 is loaded with garbage and pulled out for disposal, a new waste bag is pulled out from the roller 52 through the opening 54 along with the old waste bag, so as to facilitate the replacement of new waste bags; when the waste bags inside the roller 52 have been used, and a new roll of waste bags is to be replaced, it is possible to take off the roller cap 55 (Please refer to FIG. 1), so that the user can replace it with a new roll of waste bags.

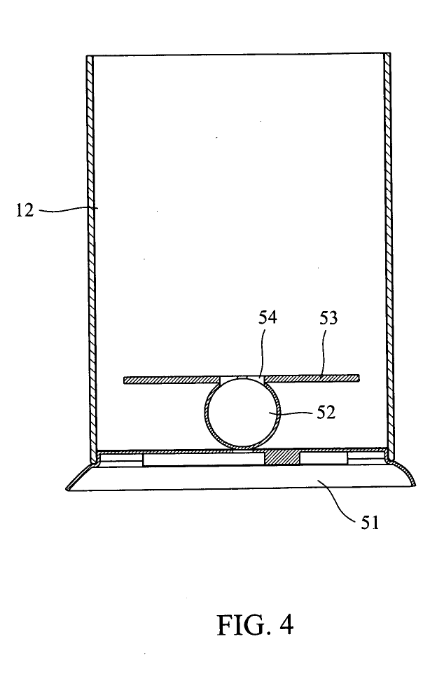

As shown in FIG. 4, the body 2 is fastened on the basket base 5, which comprises a base 51, a roller 52 and a supporting base plate 53; the base 51 is fastened on the basket base 5 and is used to dispose the body 2 to provide a support for the entire product; the roller 52 is fastened on the base 51, and has an opening 54, which is used to place waste bags, and the supporting base plate 53 is fastened on the roller 52 and is used to support waste bags; a roller cap 55 passes through a hole (which is not shown in the drawing) of the body 2 and then is sleeve jointed to the roller 52.

The user can place a roll of waste bags inside the roller 52 in advance, and when the waste bag on the supporting base plate 53 is loaded full of garbage and pulled out for disposal, a new waste bag is pulled out from the roller 52 through the opening 54 along with the old waste bag, so as to facilitate the replacement of new waste bags; when the waste bags inside the roller 52 have been used, and a new roll of waste bags is to be replaced, it is possible to take off the roller cap 55, so that the user can replace it with a new roll of waste bags.

The advantage of the present invention is characterized in that the user can place the entire roll of waste bags inside the roller of the waste paper basket in advance, and then directly pull out the waste bag if necessary; when the waste bag is loaded with garbage and pulled out for disposal, it is possible to directly pull out another waste bag, so that a new waste bag can automatically be pulled out along with the old waste bag, to facilitate the replacement of waste bags.

While the invention has been described by way of examples and in terms of preferred embodiments, it is to be understood that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures.

1. A waste paper basket comprising: a body, a lid, a pedal unit, a basket base, a pivotal portion and a fixation portion, said pedal unit comprising a pedal and a linkage, said linkage connected to said pedal and said lid, said body being sleeve jointed to said basket base, and said lid being sleeve jointed to said body; which is characterized in that said base comprises a base and a roller, and said roller has an opening and is disposed on said base.

2. The waste paper basket according to claim 1, wherein a supporting base plate extends to both ends of said opening of said roller.

3. The waste paper basket according to claim 1, further comprising a roller cap, said roller cap passing through said body and then being sleeve jointed to said roller.

4. A waste paper basket comprising: a body and a basket base, -said body being a hollow barrel and being fastened on said basket base; which is characterized in that said basket base comprises a base and a roller, said roller has an opening and is disposed on said base.

5. The waste paper basket according to claim 4, wherein a supporting base plate extends to both ends of said opening of said roller.

6. The waste paper basket according to claim 4, further comprising a roller cap, said roller cap passing through said body and then being sleeve jointed to said roller.
